(19) United States
(12) Patent Application Publication
(10) Pub. No.: US 2024/0386636 A1
(43) Pub. Date: Nov. 21, 2024

(54) IMAGING APPARATUS SYSTEM AND SERVER APPARATUS

(71) Applicant: Panasonic Intellectual Property Management Co., Ltd., Osaka (JP)

(72) Inventors: Takaaki YAMASAKI, Osaka (JP); Shinichi YAMAMOTO, Osaka (JP)

(73) Assignee: Panasonic Intellectual Property Management Co., Ltd., Osaka (JP)

(21) Appl. No.: 18/663,223

(22) Filed: May 14, 2024

(30) Foreign Application Priority Data
May 17, 2023 (JP) 2023-081812

(51) Int. Cl. G06T 11/60; G06F 3/01; G06V 20/40; G06V 40/16; G10L 25/63

(52) U.S. Cl. CPC G06T 11/60; G06F 3/013; G06V 20/44; G06V 40/174; G10L 25/63

(57) ABSTRACT

An imaging apparatus system includes: one or more image sensors; an interface device for acquiring data; a storage; and one or more signal processing circuits. The one or more image sensors generate video data by capturing images. The interface device acquires at least one of audio data acquired during image capturing and biometric data that is biometric information of a user acquired during the image capturing. The storage records a data set in which at least one of the audio data and the biometric data is correlated with the video data. The one or more signal processing circuits determine an emotion the user felt regarding an event that was occurring at the time of the image capturing, using at least one of the video data, the audio data, and the biometric data, and that execute an image editing process on the video data depending on the determined emotion.

### CROSS REFERENCE TO RELATED APPLICATION

This application claims benefit of priority to Japanese Patent Application 2023-081812, filed on May 17, 2023, the entire content of which is incorporated herein by reference.

### BACKGROUND

### Technical Field

The present disclosure relates to an imaging apparatus system and a server apparatus.

### Related Art

JP 2019-047234 A discloses a technique for calculating an emotional index for each subject and processing the image into an image that approximates the impression a photographer has. The information processing apparatus described in JP 2019-047234 A records, along with captured image data, data regarding the photographer's attention level and emotion for each subject appearing in the image data, and performs predetermined image processing based on the recorded data. It becomes possible to reproduce the sense of being there, for example, by enlarging and reproducing a specific subject so as to approximate the way it looks with the naked eye of the photographer, i.e., his/her impression. JP 2019-047234 A is a technique that estimates emotions “for each subject” and reflects the emotions on images. The description in JP 2019-047234 A is generally limited to still images, and although there is some reference to moving images, it is not clear how they are processed.

### SUMMARY

An object of the present disclosure is to express emotions of a user, who is an photographer or a videographer, by processing a video depending on emotions the user has obtained by experiencing an event.

An imaging apparatus system according to an aspect of the present disclosure includes one or more image sensors that generate video data by capturing images; an interface device for acquiring data; a storage; and one or more signal processing circuits. The interface device acquires at least one of audio data acquired during image capturing and biometric data that is biometric information of a user acquired during the image capturing. The storage records a data set in which at least one of the audio data and the biometric data is correlated with the video data. The one or more signal processing circuits determine an emotion the user felt regarding an event that was occurring at the time of the image capturing, using at least one of the video data, the audio data, and the biometric data. The one or more signal processing circuits execute an image editing process on the video data depending on the determined emotion.

A server apparatus according to an aspect of the present disclosure is used in an imaging apparatus system having an imaging apparatus. The imaging apparatus includes: one or more image sensors that generate video data by capturing images; a microphone that generates audio data; and an interface device for acquiring biometric data. The imaging apparatus further includes a transmission circuit that transmits the video data and at least one of the audio data and the biometric data. The server apparatus includes: a communication circuit that communicates with the imaging apparatus; a storage; and one or more signal processing circuits. The storage records a data set in which at least one of the audio data and the biometric data is correlated with the video data received by the communication circuit. The one or more signal processing circuits determine an emotion the user felt regarding an event that was occurring at the time of the image capturing, using at least one of the audio data and the biometric data. The one or more signal processing circuits execute an image editing process on the video data depending on the determined emotion or analyzes an event indicating a factor of the user's emotion to generate factor analysis data.

According to the present disclosure, the emotions of the user, who is the photographer or videographer, can be expressed by processing a video depending on emotions the user has obtained by experiencing an event.

### BRIEF DESCRIPTION OF DRAWINGS

FIG. 1 is a block diagram showing a configuration of an imaging apparatus system according to a first embodiment of the present disclosure;

FIG. 2 is a block diagram showing internal configurations of smart glasses and a server apparatus;

FIG. 3 shows an example of the appearance of the smart glasses;

FIG. 4 shows the smart glasses worn by a user;

FIG. 5 shows a procedure of processing performed in the imaging apparatus system;

FIG. 6 shows examples of services that can be provided using the imaging apparatus system;

FIG. 7A shows an example of adding an image effect based on a determined emotion to video data;

FIG. 7B shows an example of adding an image effect based on a determined emotion to video data;

FIG. 7C shows an example of adding an image effect based on a determined emotion to video data;

FIG. 7D shows an example of adding an image effect based on a determined emotion to video data;

FIG. 7E shows an example of adding an image effect based on a determined emotion to video data;

FIG. 8 shows a display example of a monthly graph of the frequency of positive events that enhanced QoL;

FIG. 9 shows a display example of items in which a certain user is interested, extracted using the user's video data, audio data, motion data, biometric data, and line-of-sight data;

FIG. 10 shows a display example of event analysis data provided by a monitoring service;

FIG. 11 shows a procedure for providing a selected service by selecting a service menu from a user terminal;

FIG. 12 shows examples of factors or processing methods used to execute video editing processes based on emotions of the user who took the video;

FIG. 13 shows a method for determining each individual emotional index and an example of its numerical value;

FIG. 14 illustrates an example of processing to enhance a video;

FIG. 15 illustrates determining the emotion of enjoying dancing and thereby displaying on the video data an avatar that shows the user enjoying dancing;

FIG. 16 shows an example of a CPU acting as a switcher and performing an emotion determination function; and

FIG. 17 illustrates determining that the food looks delicious and the emotion of being delicious when taking a meal on a live broadcast, to subject video to an image editing process.

### DETAILED DESCRIPTION

Embodiments will now be described in detail with appropriate reference to the drawings. However, more detailed explanations than necessary may be omitted. For example, detailed explanations of already well-known matters and duplicate explanations for substantially the same configurations may be omitted. This is to avoid unnecessary redundancy in the following description and to facilitate the understanding of those skilled in the art.

The inventors provide the accompanying drawings and the following description in order that those skilled in the art fully understand the present disclosure, but do not intend to thereby limit the subject matter defined in the appended claims. Hereinafter, the term “photographer” is used broadly to include not only those who take pictures but also those who shoot videos. In addition, hereinafter, the term “image editing process” is used broadly to include not only the process of editing images but also that of editing videos.

### 1. First Embodiment

### 1-1. Configuration Example of Imaging Device System

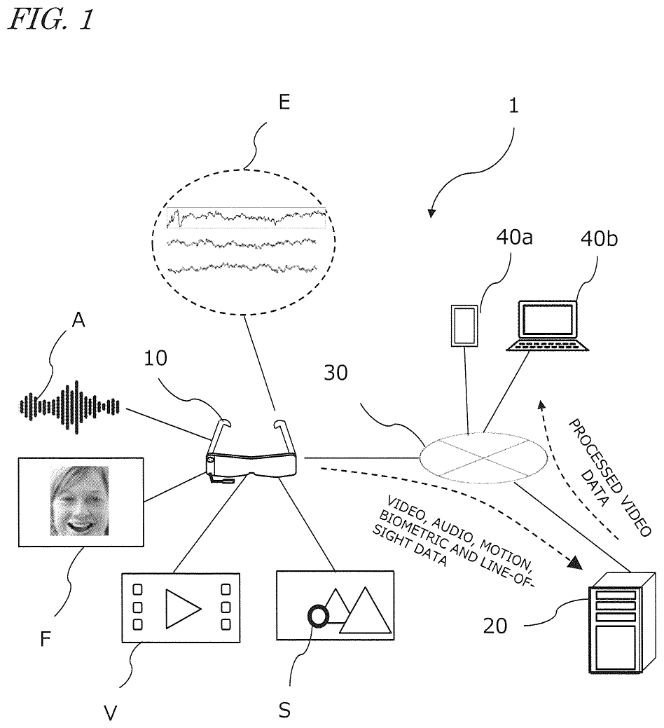

FIG. 1 is a block diagram showing a configuration of an imaging apparatus system 1 according to a first embodiment of the present disclosure. The imaging apparatus system 1 includes, for example, smart glasses 10 acting as an imaging apparatus, and a server apparatus 20. The smart glasses 10 and the server apparatus 20 are capable of communicating with each other via a telecommunications line 30 typified by the Internet, for example. The imaging apparatus system 1 may further include a smartphone 40a and a PC 40b.

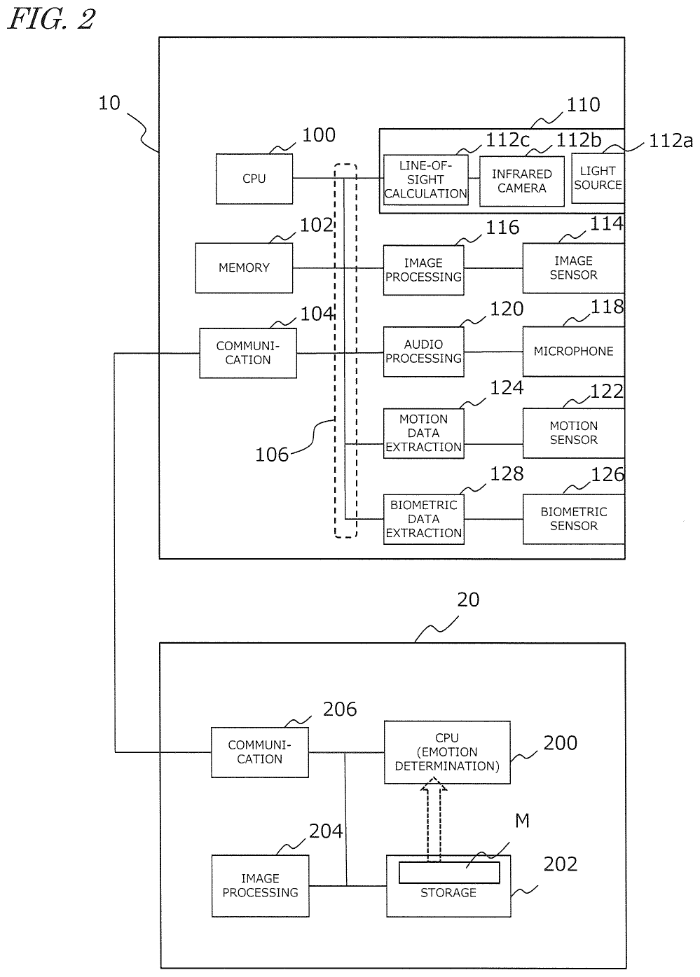

FIG. 2 is a block diagram showing internal configurations of the smart glasses 10 and the server apparatus 20. As shown in FIG. 2, the smart glasses 10 include a CPU 100, a memory 102, a communication circuit 104, and an interface device 106. The smart glasses 10 further include various sensors 110, 114, 118, 122, and 126, and circuits 112, 116, 120, 124, and 128 that process sensor signals from the sensors. Inside the smart glasses 10, the constituent elements can exchange data via a communication bus.

A line-of-sight sensor 110 detects a line of sight of the user wearing the smart glasses 10. The line-of-sight sensor 110 includes an infrared light source (infrared LED) 112a, an infrared camera 112b, and a line-of-sight calculation circuit 112c. The infrared light source 112a irradiates an eyeball with infrared rays so that the infrared camera 112b captures a video image of the eyeball. Then, using the captured video image, the line-of-sight calculation circuit 112c detects the position of a corneal reflection image of the light source on a pupil and a corneal surface. The line-of-sight calculation circuit 112c stores in advance a relationship between the position of the corneal reflection image and viewpoint coordinates on the video image captured by the infrared camera 112b. The line-of-sight calculation circuit 112c measures which part of the captured video image the user is directing his or her line-of-sight to, based on the positional relationship with the corneal reflection image as a reference point and the pupil as a moving point. In this embodiment, the position of intersection of this line-of-sight and the video image is referred to as line-of-sight data S. In FIG. 1, the user's line-of-sight in a landscape is schematically shown as line-of-sight data S.

The image sensor 114 is an example of an image capturing device. Since a well-known CMOS image sensor can be used as the image sensor 114, a description of its specific configuration will be omitted. The image sensor 114 outputs a charge signal. The image processing circuit 116 generates still image data from the charge signal. Video data is obtained by continuously generating still image data. The smart glasses 10 of this embodiment include an out-camera 114a and an in-camera 114b. Although two image sensors may be disposed in each of the out-camera 114a and the in-camera 114b, for convenience, the image sensors of the out-camera 114a and the image sensor of the in-camera 114b may be described herein as an image sensor 114a and an image sensor 114b, respectively.

The smart glasses 10 of this embodiment include an out-camera for capturing images of the outside world and an in-camera for capturing images of the face of the user wearing the smart glasses 10. The out-camera generates video data V, while the in-camera generates face data F obtained by capturing images of the user's face (FIG. 1).

The microphone 118 is an audio sensor that converts sound traveling through the surrounding space into electrical signals. The audio processing circuit 120 extracts only the audio uttered by the user based on the input volume level, for example, and outputs it as audio data A (FIG. 1).

The motion sensor 122 is, for example, a so-called 9-axis sensor having an inertial sensor including a 3-axis acceleration sensor and a 3-axis gyro sensor, and a 3-axis geomagnetic sensor, housed in a single housing. The motion data extraction circuit 124 generates data on motion detected by the motion sensor 122, from the output signal from the motion sensor 122. A plurality of motion sensors 122 may be attached to the user's wrists, both limbs, head, and the like. Alternatively, if a motion capture sensor having a band type, clothing type, etc. that is easy to wear on the body is used as the motion sensor 122, motion data indicating body motion can be easily acquired with high accuracy. In these cases, the motion data extraction circuit 124 may generate motion data by use of the output signal from each motion sensor 122 acquired using wireless communication that uses Bluetooth (registered trademark) between the smart glasses 10 and each motion sensor 122. If this type of motion sensor 122 is used, the motion of the user's whole body can be acquired with high precision.

The biometric sensor 126 is a general term for sensors that collect biosignals of the user. In this embodiment, the biometric sensor 126 is a sensor that detects at least one of body temperature, blood pressure, heart rate, and brain waves, for example. When the biometric sensor 126 detects body temperature, it is called a thermometer, when it detects blood pressure, it is called a sphygmomanometer, when it detects heart rate, it is called a heart rate monitor, and when it detects brain waves, it is called an electroencephalograph. Various biosignals are obtained from the biometric sensor 126. The biometric data extraction circuit 128 extracts necessary data from thereamong. For example, if the biometric sensor 126 is an electroencephalograph, it outputs as biometric data E the obtained EEG signal itself, a specific frequency component of the EEG specified in advance, or the peak value of the EEG after a certain period of time, for example, 300 ms has elapsed from the input of the stimulus (FIG. 1). Similarly, when the biometric sensor 126 is a thermometer, sphygmomanometer, or heart rate monitor as described above, it extracts necessary data as biometric data E (FIG. 1).

The server apparatus 20 includes a CPU 200, a storage 202, an image processing circuit 204, and a communication circuit 206.

The server apparatus 20 receives video data, audio data, motion data, biometric data, and line-of-sight data from the smart glasses 10 via the communication circuit 206. The CPU 200 stores those pieces of data in the storage202 as a data set in which they are correlated with each other based on the same acquisition time. The storage 202 is a general term for a primary storage apparatus that is a random access memory (RAM) and a secondary storage apparatus such as a hard disk drive (HDD) or a solid state drive (SSD). In this embodiment, the storage 202 stores an event prediction model M in advance. The event prediction model M is read into the CPU 200 for use therein for example. A specific description of the event prediction model M will be given later. In this embodiment, the description will be given assuming that video data, audio data, biometric data, and line-of-sight data are transmitted and received between the smart glasses 10 and the server apparatus 20 and that a data set including these data is stored in the storage 202. However, it is not necessary that all of this data is constantly sent and received to form a data set. Ultimately, it is sufficient for a data set that at least one of audio data and biometric data is correlated with video data.

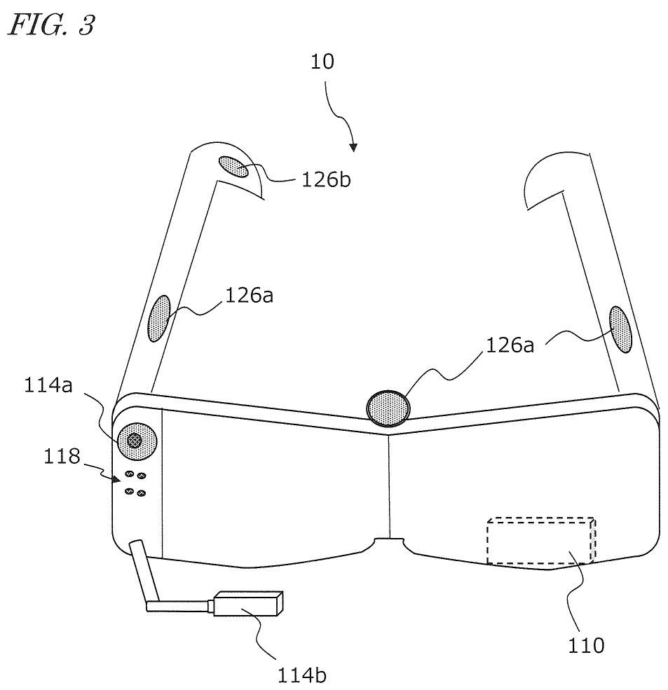

FIG. 3 shows an example of the appearance of the smart glasses 10. According to FIG. 3, the respective arrangements in the smart glasses 10 can be understood of the line-of-sight sensor 110, the out-camera 114a and in-camera 114b acting as image sensors, the microphone 118, and the electroencephalograph 126a and thermometer 126b as biometric sensors. The in-camera 114b has, for example, a wide-angle lens, an ultra-wide-angle lens, or a fisheye lens, and is capable of capturing an image of at least a portion of the user's face, desirably the entire face.

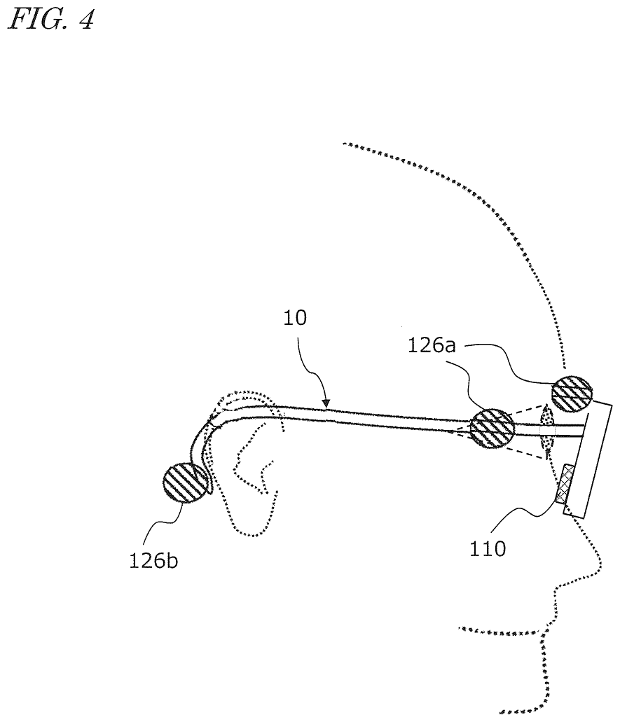

FIG. 4 shows the smart glasses 10 worn by a user. The line-of-sight sensor 110 is arranged so as to be able to irradiate infrared light onto the user's eyeballs to capture an image. The electroencephalograph 126a and the thermometer 126b are arranged at positions where they can measure the user's brain waves and body temperature, respectively. Note that depending on the type of brain waves to be obtained, it is preferable to dispose the electrodes of the electroencephalograph 126a at a position where the brain waves can be easily measured.

Although in this embodiment, the various sensors are mounted on the smart glasses 10, this is merely an example and it is not necessary to dispose all the sensors and the circuits for processing sensor signals in one housing. Some or all of the various sensors and circuits may be disposed outside the housing, and data may be received from the outside via the interface device 106.

### 1-2. Operation of Imaging Apparatus System 1 and Services That Can Be Provided Using Imaging Apparatus System 1

### 1-2-1. Overview of Operation of Imaging Apparatus System 1

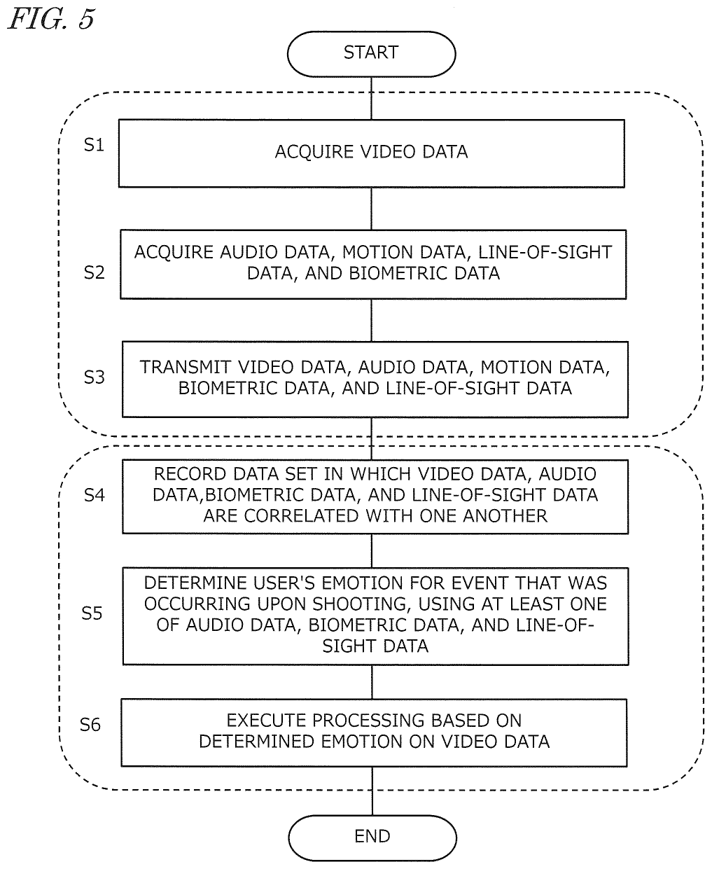

The action of the imaging apparatus system 1 will be described below with reference to FIG. 5. For the sake of convenience of understanding, the description will be given using an example.

FIG. 5 shows a procedure of processing performed in the imaging apparatus system 1. It is in the form of a flowchart for ease of understanding. It should be noted that this flowchart represents a process that is not executed by a specific arithmetic circuit such as a CPU but is performed in cooperation by the smart glasses 10 and the server apparatus 20 that constitute the imaging apparatus system 1. Steps S1 to S3 in FIG. 5 are processes performed by the smart glasses 10, while steps S4 to S6 are processes performed by the server apparatus 20.

At step S1, the CPU 100 of the smart glasses 10 acquires video data generated by the image sensor 114. At step S2, the CPU 100 acquires audio data, motion data, line-of-sight data, and biometric data generated by the circuits related to the microphone 118, motion sensor 122, and biometric sensor 126, respectively.

At step S3, the CPU 100 transmits the acquired video data, audio data, motion data, biometric data, and line-of-sight data to the server apparatus 20 via the communication circuit 104 and the telecommunications line 30.

At step S4, the CPU 200 of the server apparatus 20 receives the video data, audio data, biometric data, and line-of-sight data through the communication circuit 206, and records them in the storage 202 as a data set in which they are correlated with each other. At step S5, the CPU 200 uses at least one of the audio data, biometric data, and line-of-sight data to determine the emotion the user had regarding an event that was occurring at the time of shooting. As used herein, an “event” refers to an event or a user's experience that appeals to at least one of the user's five senses, namely, sight, hearing, taste, smell, and touch. The user's experience includes both an experience attributable to the user's active actions and a passive experience not attributable to the user's actions.

At step S6, the CPU 100 instructs the image processing circuit 204 to execute an image editing process on the video data depending on the determined emotion.

Steps S5 and S6 will be explained using a specific example.

The CPU 200 of the server apparatus 20 performs an emotion determination function that will be described later. The CPU 200 predicts an event that the user is experiencing using various types of data received from the smart glasses 10 and an event prediction model M that has been implemented in advance by, for example, machine learning, and further determines the emotion felt by the user through the experience of the event. The CPU 200 determines whether to add a text or an image representing a mental image and/or a sentiment of the user who experienced the event, or to add the user's face image. The image processing circuit 204 adds an image effect corresponding to the determined emotion to the video data.

For example, when the user is experiencing an event called “soba noodle making”, the CPU 200 estimates that the event is soba noodle making, from the acquired line-of-sight data and motion data and the event prediction model M. Then, based on the motion and line of sight of the user spreading, folding, and shredding the dough with a knife in a certain motion, the CPU 200 determines the user's mental image and/or sentiment, or more directly, the “cry of the heart”, such as “This is fun”.

The image processing circuit 204 of the server apparatus 20 executes an image editing process on the video data depending on the determined emotion. In the example of soba noodle making described above, the image processing circuit 204 adds characters representing the user's emotion, “This is fun”, to the video data over a certain playback time length to express the user's heart's cry as characters.

### 1-2-2. Services that can be Provided Using Imaging Apparatus System 1

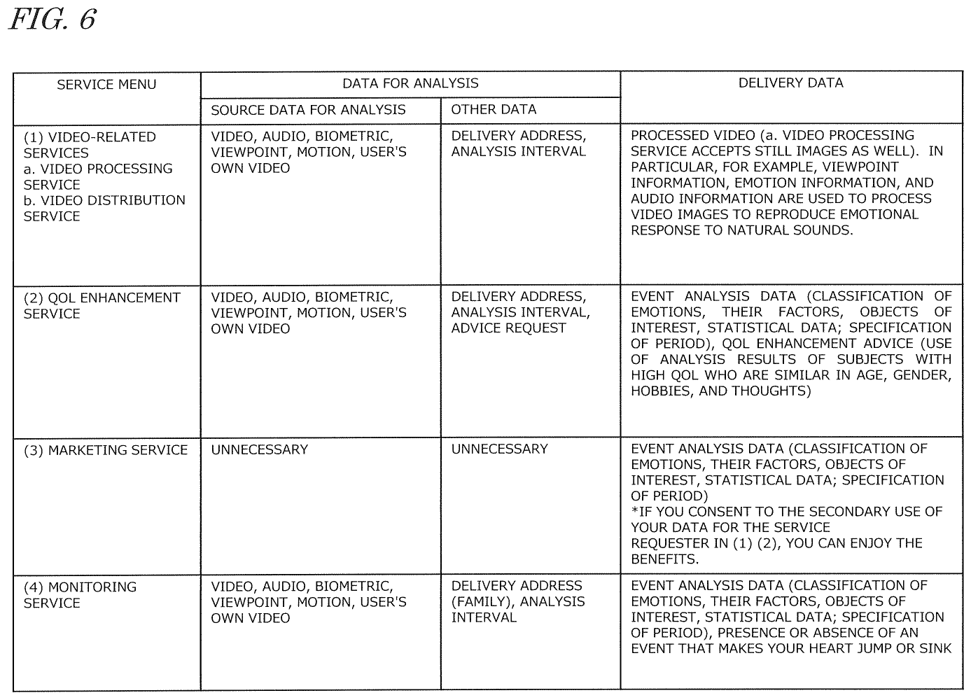

FIG. 6 shows examples of services that can be provided to a user using the imaging apparatus system 1.

A menu of services provided is shown in the leftmost column. In this specification, as (1) video image related services, “a. video image processing service” and “b. video distribution service” can be provided. In addition, (2) services to enhanced quality of life (QOL), (3) marketing services, and (4) monitoring services for the elderly, etc. can be provided.

In FIG. 6, data required when providing each of the services (1) to (4) above to a user using the imaging apparatus system 1 is shown as “analysis data”. The analysis data is data sent from the user's smart glasses 10 to the server apparatus 20. The main data is as illustrated as “source data for analysis,” and the data used incidentally is shown as “other data”. In the rightmost column, data provided to the user as each of the services (1) to (4) above is shown as “delivery data.”

### (1) Video Image Related Services

A service for processing videos or still images is provided. For example, the estimated emotion, viewpoint data, audio data, etc. are used to process video images to reproduce the shooting subject's emotional response to sound. The “source data for analysis” in this service includes video, audio, biometric, viewpoint, motion, and user's own video data. The video is first video data acquired by the out-camera, and in this service, the first video data is essential for processing. It is also possible for the user to wish to combine the user's own still image and video images in this service, and the still image is extracted using second video data acquired by the in-camera. Note that not all of the audio, biometric body, viewpoint, motion, and user's own video data are essential, as long as at least one data is used. Among the “other data,” the analysis interval refers to a specific interval of the video data to be processed. By specifying a certain time interval, an image effect is added that shows the user's “heart's cry” at an event occurring in that interval. The “delivery data” to the user is, for example, a processed video to which is added a text expressing the user's emotion such as “This is fun!”. It may be a still image. If the user is experiencing an event in which he/she is in contact with an urban scenery, a mountain scenery, etc., the CPU 200 of the server apparatus 20 can process the video images to reproduce the emotional response to the natural sound in the video data, especially with the viewpoint, emotion, and audio. The processed video data is sent to the e-mail address, etc. specified as the “delivery address”.

### (2) QoL Enhancement Service

The QoL enhancement service provides event analysis data. The event analysis data includes classification of emotions, their factors, events/objects of interest, and statistical data. If a specific period of time is specified for a video, data analyzed for that period of time is provided. The results of the analysis of test subjects with high QOL who are similar in age, gender, hobbies, and thoughts are also used to provide advice on enhancing QOL.

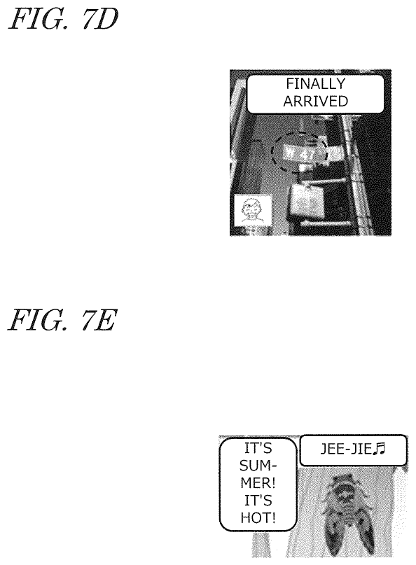

For example, event analysis data can determine factors that led to enhanced QOL. One of the factors enhancing QoL is being moved by an experience or event. When the user is moved by nature such as scenery, sunset, starry sky, streams, etc., line-of-sight stays and/or image stays can be detected. By acquiring the user's face data and audio data using the in-camera and microphone, it is possible to determine from the user's facial muscles and voice that the user was happy or laughed when watching a video, eating, watching sports, etc. By counting and displaying these factors that enhance QOL, the user's QOL and its changes can be quantified. FIG. 8 is a display example of a monthly graph of the frequency of positive events that enhance QoL.

On the other hand, factors that decrease QoL can also be determined by using the event analysis data. It can be detected that someone is angry, sad, or crying from video data, audio data, biometric data such as heartbeat, etc. These are negative factors that make you depressed due to sadness or anger. Also by counting and displaying these factors that decrease QOL, the user's QoL and its changes can be quantified.

Following the example of FIG. 8, the frequency of negative events that decreased QOL may be graphed on a monthly basis. Alternatively, the calculation may be performed using monthly positive factors, negative factors, and the total of positive and negative factors. By showing the average age of users, for example, with a broken line, it is also possible to know the relative level of QoL of that user.

Since the trend can be analyzed of what type of events enhanced or decreased the QoL of that user, it is also possible to present advice on how to use the analysis results to enhance the QoL.

Note that, similar to the above (1) video image related services, the “source data for analysis” in this service includes video, audio, biometric, viewpoint, motion, and user's own video data. However, not all of these are required. For example, it is sufficient to have at least one of the audio and biometric for the data of video and/or the user's own video.

### (3) Marketing Service

Event analysis data is provided by marketing services such as sales promotion data and personal advertisements. The event analysis data includes classification of emotions, their factors, and objects of interest. It may also include statistical data. If a specific period of time in the video is specified, data analyzed for that period of time is provided. For example, if a requester receiving the above services (1) and/or (2) consents to the secondary use of his or her own data, the requester can enjoy benefits.

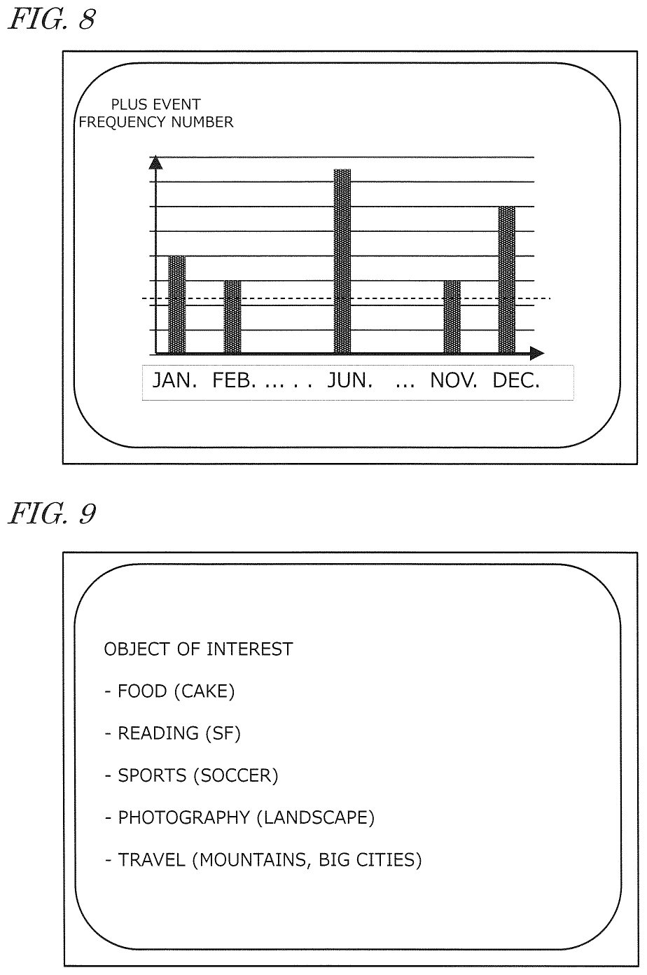

FIG. 9 shows a display example of items in which a certain user is interested, extracted using the user's video data, audio data, motion data, biometric data, and line-of-sight data. By using these pieces of information, it is possible to display advertisements targeted at the user or guide the user her to a purchasing site.

### (4) Monitoring Service (Behavior History)

Event analysis data is provided. The event analysis data includes classification of emotions, their factors, and objects of interest. It may further include statistical data. If a specific period of time in the video is specified, data analyzed for that period of time is provided.

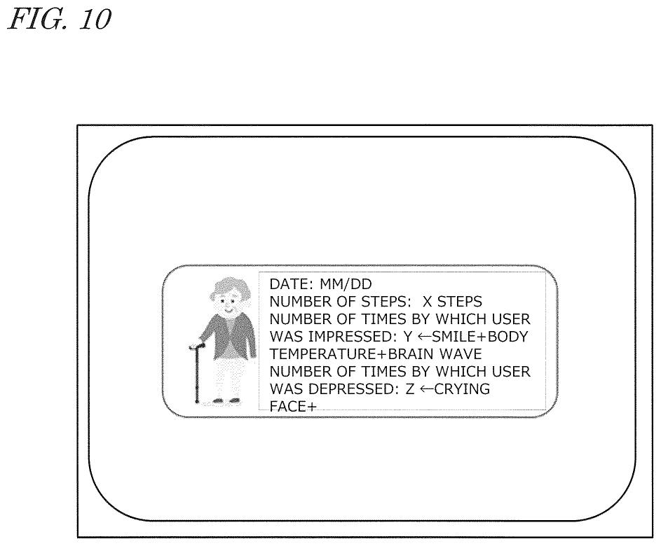

Suppose that a request is received from a family of a user to watch over that user. In that case, the family of the user is presented with event analysis data that includes the number of steps the user has taken, the number of times the user has been moved, the number of times the user's heart has sunk, etc., which are calculated using the acceleration sensor 122. FIG. 10 shows a display example of event analysis data provided by the monitoring service. By displaying such case analysis data, the user's family can grasp the user's condition even from a remote location, for example.

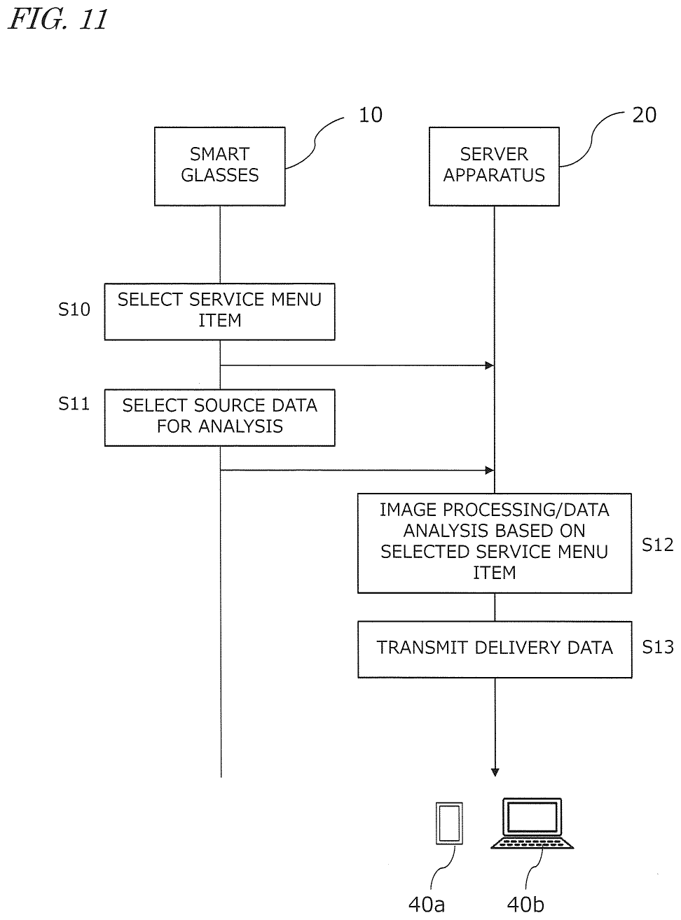

The four types of services described above can be arbitrarily selected by the user. FIG. 11 shows a procedure for providing a selected service by selecting a service menu from a user terminal. Although the user terminal is assumed to be the smart glasses 10, it may be a terminal apparatus that the user has separately from the smart glasses 10. It is assumed that each user terminal has an input interface (not shown) that accepts a user's operation to select a service menu. For example, assume that the smart glasses 10 have a function of projecting a service menu. The smart glasses 10 may include an input interface that allows the user to select one of a plurality of service menus by sliding the user's finger back and forth along a temple of the glasses while being in touch therewith and to determine the selected service menu by tapping the temple.

At step S10, the CPU 100 of the smart glasses 10 accepts a selection from the user of one of the four service menus described above on the smart glasses 10. At step S11, the CPU 100 extracts, as the source data for analysis, the source data for analysis specified in advance by the user based on the criteria shown in FIG. 6, and transmits it to the server apparatus 20. In other words, not all the source data for analysis need not be transmitted to the server apparatus 20 by the user.

At subsequent step S12, the CPU 200 of the server apparatus 20 performs image processing or analysis based on the selected service menu, using the received source data for analysis, to generate factor analysis data or event analysis data. Then, at step S13, the CPU 200 transmits the image-processed video data or factor analysis data as delivery data. The destination of the transmission is specified in advance by the user as shown in FIG. 6. In the example of FIG. 11, the data can be confirmed using the smartphone 40a or the PC 40b.

### 1-3. Details of Action of Imaging Apparatus System 1

Details of the action of the imaging apparatus system 1 will then be described.

Although the following describes details of (1) video image related services, (2) to (4) can also be performed by using the program on the smart glasses 10 side and the program on the server apparatus 20, which execute the processing described in (2) to (4) in addition to the contents of (1).

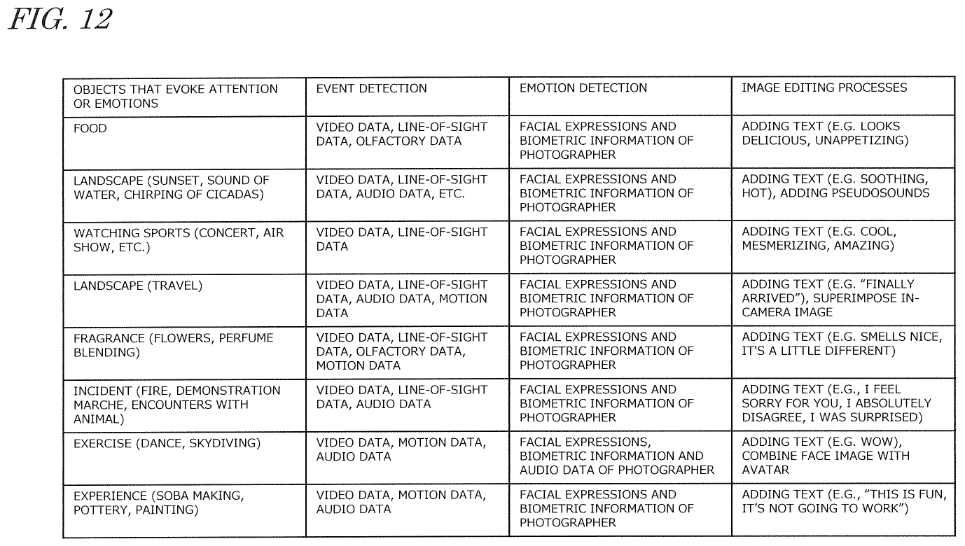

FIG. 12 shows various examples of objects that may evoke attention or emotions, and events and emotions that are detected in relation to each of the objects, and image editing processes related therewith. Note that these are mere examples.

First, the scenery existing in front of a user capturing images of a landscape, etc. and the experiences or events taking place within the environment in which the user is capturing the images, can be factors that evoke the user's attention and emotions.

To determine such an object, the CPU 200 of the server apparatus 20 first determines what environment the user is currently in, based on video data acquired by the out-camera 114a of the smart glasses 10 and/or audio data acquired from the microphone 118. In other words, scene determination can be performed from the video data and/or audio data and the event prediction model M. In addition, the CPU 200, which also performs an emotion determination function, determines the user's emotion at the time of capturing images, mainly using face data acquired by the in-camera 114b. The “user's emotion” is an emotion that the user had with respect to an event that was occurring during video shooting. The server apparatus 20 includes a table that, for each type of event, correlates each of a plurality of types of emotions (positive emotions and negative emotions) with each of a plurality of image editing processes of video data. The CPU 200 refers to the table based on the predicted event type and emotion to determine an image editing process. Note that when a certain emotion is correlated with one image editing process, for example, with superimposed display of a message, there may be a plurality of such messages. In other words, a single image editing process may include a plurality of processing modes. In such a case, it is desirable to randomly select one image editing process from a plurality of processing modes.

Here, an event prediction model M is implemented in advance in the CPU 200, the event prediction model M generated by machine learning, based on training data in which video and/or audio containing an event as an explanatory variable is correlated with a type of event as an objective variable.

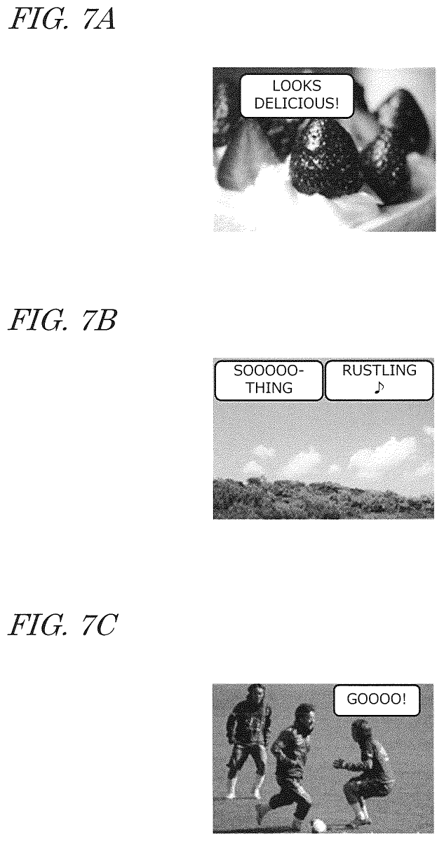

The above event prediction model M is implemented by machine learning performed in advance so that when a video of an unknown event type is input as an explanatory variable, the event type is output as a prediction result. The CPU 200 can predict events using the event prediction model M. In particular, by employing video images that include a wide variety of events as explanatory variables, it is fully possible to discriminate the events illustrated in, for example, FIGS. 7A to 7E.

Note that since the event prediction model M is configured to output a certain predicted value when given a certain input, it can be implemented as part of a computer program. Such a computer program may be stored in advance in the storage 202, for example. When predicting an event, the CPU 200 reads such a computer program into the RAM and receives a video or a still image as input, to perform the event prediction. Alternatively, the CPU 200 and the event prediction model M may be implemented as hardware using an application specific IC (ASIC), a field programmable gate array (FPGA), or a complex programmable logic device (CPLD).

Some of the various “objects that evoke attention and emotions” shown in FIG. 12 will hereinafter be illustrated and described. Although it will be described below that the CPU 200 of the server apparatus 20 executes the processing, it also includes that the CPU 200 instructs the image processing circuit 204 to execute the processing.

In FIG. 12, when the object evoking attention or emotions is food, the CPU 200 detects an event (which can also be called a shooting scene) that is food using the video data captured by the user with the out-camera 114a and the event prediction model M. If line-of-sight data is further used, the CPU 200 can also know that the user's viewpoint stays on the food, thus increasing the accuracy of event detection. If odor data is used, the accuracy of event detection can be further enhanced. The CPU 200 then detects the user's facial expression shot by the in-camera 114b, to thereby detect the user's emotion. In addition, if biometric information such as heartbeat is used, the intensity of the user's emotion can be more accurately grasped.

When the user's facial expression is smiling, i.e., when the user has a positive emotion, the CPU 200 performs an image editing process to add a text (“looks delicious”) to the video data, as shown in FIG. 7a, for example. On the other hand, if the user's facial expression is distorted, i.e., the user has a negative emotion, the CPU 200 performs, for example, an image editing process to add a text (“looks bad”) to the video data. In this way, the cry of the user's heart at the time of shooting can be expressed through image processing.

Referring to FIG. 12, a case will then be described where the object evoking attention and emotions is a landscape. The CPU 200 detects an event (which can also be called a shooting scene) that is a landscape using the video data shot by the user with the out-camera 114a and the event prediction model M. If the line-of-sight data is further used, the CPU 200 can also know that the user's viewpoint is staying at a certain site of the scenery, thus increasing the accuracy of event detection. If audio data is used, the accuracy of event detection can be further enhanced. The CPU 200 then detects the user's emotion by detecting the user's facial expression shot by the in-camera 114b. In addition, if biometric data is used, the intensity of the user's emotion can be more accurately grasped.

In the case where the user's facial expression is smiling and indicates a positive emotion, the CPU 200 performs an image editing process to add a text (“soothing˜”, “rustling”) to the video data, as shown in FIG. 7B, for example. In this way, the cries of the user's heart at the time of capturing images can be expressed through image processing. As another example, if the user's facial expression is smiling, representing a positive emotion, as shown in FIG. 7E, an image editing process is performed to add a text (“It's summer! Hot!” “Jee-jie”) to the video data. Even if cicada's chirping cannot be captured in the audio data, a pseudo-sound “jee-jie” is added to the image using the text data to enhance the sense of being there when shooting.

In this way, sound of a clear stream and chirping of a cicada included in the scenery illustrated in FIG. 12 are factors that cause the image editing process to be executed as events experienced by the user in the mountains, and the processing method may be determined based on these factors. As an example of the latter, an onomatopoeia word “saa-saa” representing sound of a clear stream, or an onomatopoeic word “jee-jie” representing chirping of a cicada may be added to the video data for emphasis.

Referring to FIG. 12, a case will then be described where the object evoking attention and emotions is watching a sports game. The CPU 200 detects an event (which can also be called a shooting scene) that is watching a sports game using the video data captured by the user with the out-camera 114a and the event prediction model M. If line-of-sight data is additionally used, it can be seen that the user's viewpoint is staying at a certain point while watching a sports game, resulting in increased accuracy of event detection. If audio data is used, the accuracy of event detection can be further enhanced. The CPU 200 then detects the user's facial expression shot by the in-camera 114b, thereby detecting the user's emotion. In addition, if biometric data is used, the intensity of the user's emotion can be more accurately grasped.

In the case where the user's facial expression is smiling, representing a positive emotion, the CPU 200 performs an image editing process to add a text (“Go!”) to the video data, as shown in FIG. 7C for example.

Next, in FIG. 12, when the object evoking attention or emotions is a trip, the CPU 200 detects an event (which can also be called a shooting scene) that is a trip using the video data captured by the user with the out-camera 114a and the event prediction model M. If the line-of-sight data is additionally used, it can be seen that the user's viewpoint is staying at a travel spot, increasing the accuracy of event detection. If audio data is used, the accuracy of event detection can be further enhanced. The CPU 200 then detects the user's facial expression shot by the in-camera 114b, thereby detecting the user's emotion. In addition, if biometric data is used, the intensity of the user's emotion can be more accurately grasped.

If the user's facial expression is a relieved expression, i.e., the user has a positive emotion, the CPU 200 performs an image editing process to add a text (“Finally arrived”) to the video data, as shown in FIG. 7D, for example. By adding the user's state of mind upon shooting to the image in this manner, the sense of being there can be enhanced when capturing images. At the same time, a still image of the user's face captured by the in-camera 114b or still image of a relieved expression of the user prepared in advance may be superimposed on the video.

The above examples show: that events such as food, scenery, watching sports games, and travel are mainly detected using video data; that emotions at that time are mainly determined from the facial expression of the photographer; and that image effects based on the determined emotions are added to the video data.

The smart glasses 10 performing such processes to generate video data may also be called an “event log camera” or a “life log camera”. The glasses-type imaging apparatus shown in FIG. 3 is suitable for acquiring event logs or life logs because it can constantly capture images as the user engages in activities. However, constant shooting increases the power consumption of the smart glasses 10 and increases the storage capacity required to record video data and other data. Installing an automatic start of shooting function and/or an automatic end of shooting function is therefore effective in reducing power consumption and storage capacity. The “automatic start of shooting function” is a function that starts shooting when, for example, biometric data increases to a predetermined threshold value or more. The “automatic end of shooting function” is a function that ends shooting when, for example, biometric data falls below a predetermined threshold during shooting. Audio data and/or motion data may be used instead of or together with the biometric data.

In this embodiment, when determining an emotion, a numerical value representing the user's sentiment is determined using line-of-sight data, motion data, odor data, face data, image data, audio data, blood pressure data, and EEG data. In this specification, the above “numerical value of sentiment” is also referred to as “emotional index”. The emotional u is a value obtained from each of video data, audio data, motion data, biometric data, and line-of-sight data, and can be defined as a numerical value representing an emotion that can be grasped from temporal fluctuations in each data. A method for the CPU 200 to determine emotion will then be described.

In this embodiment, the CPU 200 calculates an emotional index, based on an event that evokes attention or emotions. The emotional index is defined as the sum of individual emotional indices defined for each of video data, audio data, motion data, biometric data, and line-of-sight data.

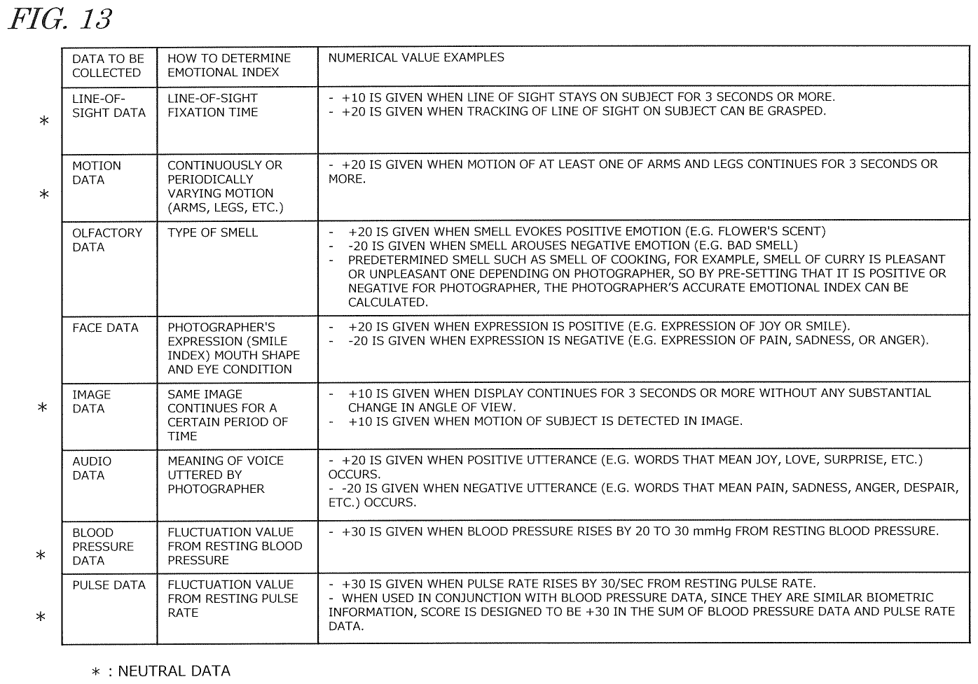

FIG. 13 shows a method for determining each individual emotional index and an example of its numerical value. In this embodiment, the CPU 200 determines to perform processing on the image/audio depending on the determined scene when the emotional index calculated as the sum of the individual emotional indices is equal to or greater than ±20 points. Note that the content of processing is determined in advance based on the content of the scene determined. It is desirable to change the content of processing depending on the number of emotional index points. It is desirable to change the content of processing depending on the number of emotional index points. For example, when the emotional index becomes higher than a predetermined value, it is conceivable to adopt a processing method that excessively expresses the content of a text added to the image during processing. More specifically, assume a scene in which the user is impressed by a setting sun. The state in which the user's line-of-sight remains in one direction (the direction of the setting sun) and in which the audio data shows silence below a predetermined value can be said to be because the user is moved. The CPU 200 thus processes the image by adding a text “I am moved beyond words˜” and adding an image of a character representing the user crying. By changing the content of processing depending on the emotional index in this manner, the cries of the heart can be expressed more accurately.

FIG. 13 shows an example of criteria for determining individual emotional indices for each of line-of-sight data, motion data, audio data, and various types of biometric data. Hence, the numerical values shown in “Numerical Examples” in FIG. 13 can be called audio reference data, motion reference data, biometric reference data, and line-of-sight reference data.

The CPU 200 derives the relationship between audio data and audio reference data. Similarly, the CPU 200 derives the relationship between motion data and motion reference data, the relationship between biometric data and biometric reference data, and the relationship between line-of-sight data and line-of-sight reference data. Assuming that the “relationship” here means a difference, the CPU 200 calculates the sum of those differences as the value of the emotional index.

According to the example shown in FIG. 13, it is understood that various types of data are collected. As in the calculation example above, it may be determined whether it is positive or negative for each of the individual emotional indices. Alternatively, some data is treated as having a “neutral” property that cannot be determined as positive or negative from itself. In FIG. 13, an asterisk (*) is attached to the left of data in the data column corresponding to neutral data.

For example, line-of-sight data, motion data, image data, blood pressure data, and pulse data are neutral data. The reason why blood pressure data is included in the neutral data is that blood pressure has a great influence on delight, anger, sorrow and pleasure emotions. The reason why the pulse data is also included in the neutral data is to prevent calculation from becoming complicated.

For the neutral data, the CPU 200 determines whether to assess the individual emotional index as positive or negative based on other biometric information. If the determination still cannot be made, the photographer's emotion may be assessed as positive or negative by scene determination using machine learning, or may be assessed as impossible to determine.

For example, even if +10 is assigned to both line-of-sight data and image data, no points are added if it is considered from the face data that the person is drowsy or otherwise in unconsciousness. Image data and audio data of a video shall be reflected on the emotional index of the photographer.

Regarding audio data, even if the user utters words that imply pain, such as “it was tough,” a comprehensive determination can be made including the tone of the voice and other biometric information (e.g., when a joyful expression is detected from the face data). As a result, it can be determined whether it is positive or negative.

NEC Corporation has released an emotion analysis solution using pulse data. NEC Corporation conducts time-series fluctuation analysis using heart rate variability analysis based on pulse rate and pulse cycle (=60 seconds/pulse rate), to identify “excitement/joy”, “calm/relaxation”, “depression/fatigue”, and “tension/stress”. However, further details are unknown.

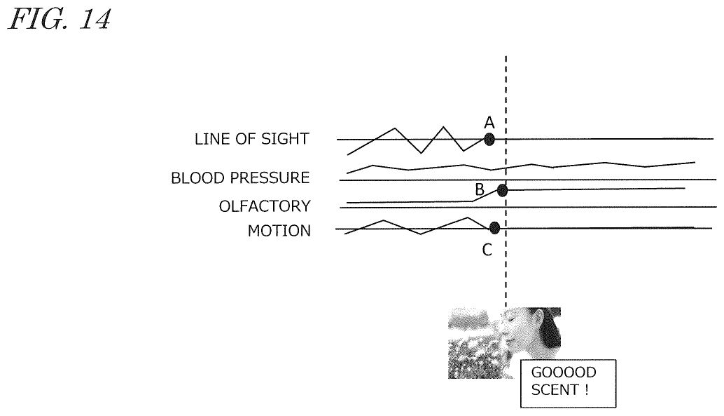

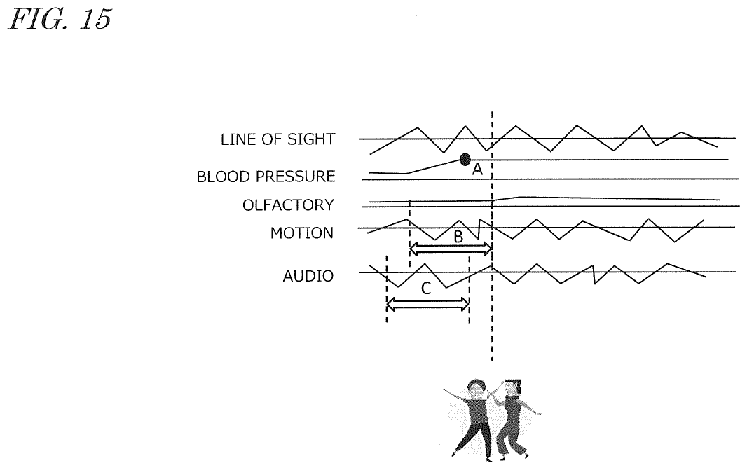

Referring then to FIGS. 14 and 15, description will be given of examples of emotion-based processing of video data and emotional indices used therein by the CPU 200 and the image processing circuit 204.

FIG. 14 illustrates an example of processing to enhance a video. In this example, an olfactory sensor (biometric sensor) is utilized in addition to the sensors in FIGS. 1 and 2, or by replacing some of the sensors. The olfactory sensor detects the presence of a scent or smell-producing object, e.g., food, flowers, etc., and is defined as a factor that evokes an emotion. As a result, the presence of such an object is treated as an event to be processed. Note that the olfactory sensor and the smell determination method can use, for example, technology announced by the National Institute for Materials Science (NIMS) on Jun. 21, 2021.

In FIG. 14, the CPU 200 first performs a scene discrimination process(=event detection process) using video data and the event prediction model M described above. Through the scene determination process, the CPU 200 determines that, based on video data from the out-camera 114a, the scene is a close-up of a flower which is a subject and that, based on video data from the in-camera 114b, the user is smelling the scent of the flower. In this case, if the line-of-sight data is used, if there is a point A where the line-of-sight stays, it is considered that there is a subject of interest to the user at the point A, so the accuracy level of the above determination can be enhanced. Similarly, if motion data is used, the reliability of the above determination can be enhanced if there is a point C where the motion stays. Note that line-of-sight data is not essential. This is because it is sufficient if the shooting scene can be identified from the video data. In order to enhance the determination accuracy, line-of-sight data may be used supplementarily.

Next, the CPU 200 mainly detects the user's emotion from the facial expression of the photographer, based on images captured by the in-camera 114b. Additionally, the CPU 200 uses odor data acquired by the olfactory sensor to determine whether the smell brings about positive emotions. In this example, the smell is assumed to be positive.

According to the line-of-sight data, the line of sight is slowly moving up and down around a certain position. The same applies to motion data and blood pressure data. These are neutral data. According to the olfactory data, smells evoking positive emotions gradually become stronger toward a point B. From these, the individual emotional index regarding smell is +20.

Overall, the CPU 200 estimates that the emotional index is 20 and that the user is feeling a pleasant scent. As a result, in response to an instruction from the CPU 200, at the time when a broken line corresponding to time B is drawn, the image processing circuit 204 superimposes an image of the user's profile taken by the in-camera 114b and a text “good fragrance˜” corresponding to the emotion on the video. In this image processing, the flower image taken by the out-camera 114a is reduced in size, the reduced image is placed on the left side of the composite image, and the user's profile image captured by the in-camera 114b is placed on the right side of the combined image. This allows the image processing circuit 204 to execute an image editing process on the video data depending on the user's emotion.

FIG. 15 illustrates determining the emotion of enjoying dancing and thereby displaying on the video data an avatar that shows the user enjoying dancing.

The video shows parts of the user's hands and arms as well as the user's face and the area around the other person's face. Suppose that music is being played as audio data. First, the CPU 200 performs scene discrimination processing using video data, motion data, and the event prediction model M described above. Through the scene determination process, the CPU 200 determines based on the video data and motion data that the scene is a scene in which two people are dancing.

Next, the CPU 200 mainly detects the user's emotion from the facial expression of the photographer, based on images captured by the in-camera 114b. In addition, it is possible by using biometric data related to blood pressure to grasp the intensity of the user's emotions. Similarly, it is possible by using audio data uttered by the user to grasp the user's positive or negative emotions.

The motion data reveals that the user is moving relatively vigorously, and the music audio data reveals that rhythmic music is being played. If the voice uttered by the user in the audio data is a positive voice, it is determined that a positive event is occurring, and the individual emotional index is added to calculate the emotional index.

Overall, the CPU 200 can determine that the user has a positive emotional index.

Here, as an example of processing, “face+avatar” is used to further emphasize the fact that it is a dance. Once face photos of the user and the other party are obtained, a composite image is generated using the face photos and avatars for body parts. The motion of the body from the neck down is reproduced by the motion obtained from the motion sensor 122. The user's face image may be an image prepared by the user in advance or a face image acquired from the in-camera 114b. The other party's face image may be an image prepared by the user in advance or a face image acquired from the out-camera 114a. Using these face images, the CPU 200 superimposes the avatar image on the video at the time when the broken line is drawn at the end of interval B of the motion data that causes the CPU 200 to create an avatar image with the avatar from the neck down. Alternatively, a predetermined frame of the video may be replaced with the avatar image. Alternatively, the avatar image may be animated to allow its limbs to move. In this way, the image processing circuit 204 executes an image editing process based on the user's emotion on video data. This makes it possible to express the user enjoying dancing.

### 1-4. Effects Etc

As described above, the imaging apparatus system 1 according to the present embodiment includes the image sensor 114 that generates video data by shooting, the interface device 106 that acquires data, the storage 202, and one or more signal processing circuits 200/204. The interface device acquires at least one of audio data acquired during shooting and biometric data that is biometric information of a user acquired during shooting. The storage records a data set in which at least one of audio data and biometric data is correlated with video data. The one or more signal processing circuits use at least one of the video data, the audio data, and the biometric data to determine the emotion that the user felt with respect to an event that was occurring at the time of the shooting. The one or more signal processing circuits execute an image editing process based on the determined emotion on the video.

According to the above configuration, the user's emotions can be expressed by processing the video depending on the emotions the user gained by experiencing the event.

The one or more signal processing circuits grasp the event using video data and determine the emotion the user felt at the event using at least one of audio data and biometric data.

The interface device acquires line-of-sight data indicating the direction of the user's line of sight at the time of shooting. The one or more signal processing circuits grasp the event using video data and line-of-sight data and determine the emotion the user felt at the event using at least one of audio data and biometric data.

The image sensors 114 include a first image sensor 114a that shoots a predetermined subject to generate first video data and a second image sensor 114b that shoots a user's face to generate second video data. The one or more signal processing circuits grasp the event using the first video data and determine the emotion the user held at the event using the second video data and at least one of audio data and biometric data.

The one or more signal processing circuits calculates a first value from audio data, a second value from biometric data, and a third value from line-of-sight data, to determine the emotion based on the total value from the first value to the third value.

An event prediction model is implemented in advance in the one or more signal processing circuits, the event prediction model generated by machine learning, based on training data in which video images and/or audio containing an event as an explanatory variable is correlated with a type of event as an objective variable. The one or more signal processing circuits predict the type of event from at least one data and the event prediction model and determines an image editing process based on the predicted event type and emotion. The one or more signal processing circuits execute the determined image editing process on the video data.

The one or more signal processing circuits include a table that, for each type of event, correlates each of plural types of emotions with each of plural image editing processes of video data, and refers to the table based on the predicted event type and emotion to determine the image editing process.

Each of the plural image editing processes includes at least one of adding a text or an image representing the photographer's mental image and/or sentiment, and adding an image of the user.

Each of the plural image editing processes includes adding a text or an image representing the photographer's mental image and/or sentiment, generated from audio data or biometric data.

The server apparatus 20 according to this embodiment is a server apparatus used in the imaging apparatus system 1 having the imaging apparatus 10. The imaging apparatus includes the image sensor 114, the microphone 118, the interface device 106, and the transmission circuit 104. The image sensor generates video data by shooting. The microphone generates audio data. The interface device acquires biometric data. The transmission circuit transmits video data and at least one of audio data and biometric data.

The server apparatus includes the communication circuit, the storage, and the one or more signal processing circuits. The communication circuit communicates with the imaging apparatus. The storage records a data set in which at least one of audio data and biometric data is correlated with the video data received by the communication circuit. The one or more signal processing circuits determine the emotion the user felt with respect to the event that was occurring at the time of shooting, using at least one of audio data and biometric data. The one or more signal processing circuits generate factor analysis data by executing an image editing process on the video data depending on the determined emotion or by analyzing an event indicating a factor of the user's emotion.

According to the above configuration, it is possible to express the user's emotions by processing the video, or it is possible to determine the factors that have led to the enhancement or deterioration of the user's QoL.

The server apparatus accepts a request for generating processed video data or creating factor analysis data via the communication circuit. The one or more signal processing circuits generate processed video data or creates factor analysis data, depending on the content of the request.

The factor analysis data generated by the one or more signal processing circuits includes factor analysis data preferred by the user and/or factor analysis data not preferred by the user.

The server apparatus accepts, via the communication circuit, a specification of a specific interval of video data to be processed.

### 2. Variant

“Live streaming” is an example of a configuration for selecting a video to be used for an image editing process when performing live streaming. For example, consider a situation where live streaming is being performed using a plurality of cameras. Suppose that a plurality of cameras are present and that a plurality of users are being captured by the plurality of cameras. The camera can be switched and display images depending on the magnitude of the numerical value of each user's estimated sentiment at the live event. Camera switching may be achieved using a switcher.

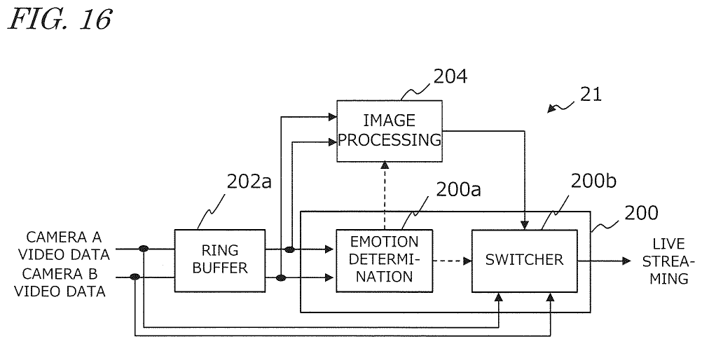

FIG. 16 shows a schematic configuration of a server apparatus 21 according to a variant. In addition to or in place of the configuration of the server apparatus 20, the server apparatus 21 is at least configured as described below and operates.

The CPU 200 includes an emotion determining logic 200a and a switcher 200b. The CPU 200 receives video data from cameras A and B via a ring buffer 202a, performs emotion determination using respective video data in the emotion determination logic 200a, and instructs the image processing circuit 204 to execute necessary image processing for camera A video data or the camera B video data. The emotion determining logic 200a outputs a control signal to the switcher 200b so as to replace the original camera A video data or camera B video data for image correction with the image processed by the image processing circuit 204. In consequent, a video image replaced with an image subjected to desired image processing is distributed as a live video image. The processing of the emotion determination logic 200a is the same as the processing of the CPU 200 described earlier. The switcher 200b may be implemented as a software switch or a hardware switch. According to these, a live streaming system is implemented.

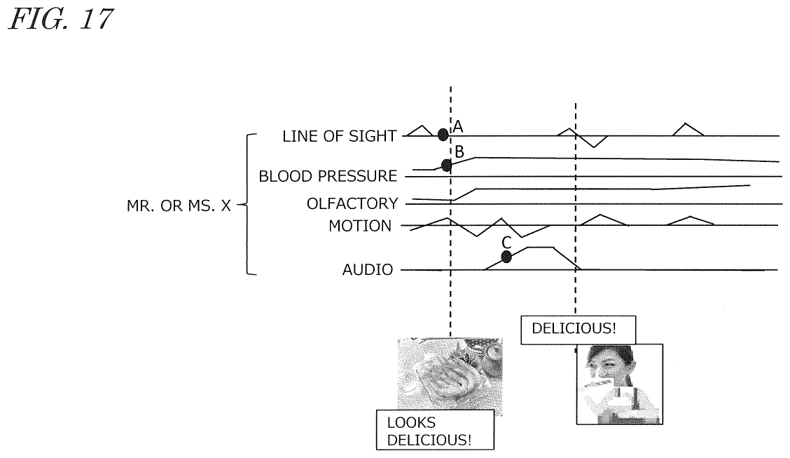

FIG. 17 illustrates determining that the food looks delicious and the emotion of being delicious when taking a meal on a live broadcast, to subject video to an image editing process.

Assume a case where Mr. or Ms. X and Mr. or Ms. Y each wear smart glasses 10 and video images captured by the smart glasses 10 are being live broadcasted. The smart glasses 10 are regarded as a camera, and Mr. or Ms. X's smart glasses 10 are described as “camera X” and Mr. or Ms. Y's smart glasses 10 are described as “camera Y” in the following. In the imaging apparatus system 1 of FIG. 1, 5G communication is used for communication between the smart glasses 10 and the server apparatus 20. At the times indicated by A and B, the CPU 200 in the server apparatus 20 determines that the scene is one in which shrimp is present as an ingredient in a dish using the first video data acquired from the out-camera 114a of the Mr. or Ms. X's camera X and the above event prediction model M, and further determines that the scene is a meal scene using the second video data acquired from the in-camera 114b of the Mr. or Ms. X's camera X. From the shooting scene at the times A and B, the CPU 200 switches the switcher (FIG. 16) from the Mr. or Ms. X's camera X video image or the Mr. or Ms. Y's camera Y video image to an image obtained by subjecting a frame in which Mr. or Ms. X is shot by the Mr. or Ms. X′ camera X to image processing. After this switching, the video image is switched again to the one before switching.

Here, the smart glasses 10 include the ring buffer 202a that can always temporarily hold first and second video data approximately 5 seconds before the current shooting point of time. The ring buffer 202a may be included in the storage 202. The CPU 200 uses the buffered first and second video data to operate event detection, emotion detection by calculating an emotion index, and video processing in parallel with video shooting, by replacing the captured video with a processed video for output to the exterior. By using this configuration, when Mr. or Ms. X generates a sound “delicious˜” at time C, the CPU 200 can process the image to have a face part with the Mr. or Ms. X's face and an avatar's body part, for output, after the sound is generated.

In FIGS. 1 and 2, description has been made assuming that the smart glasses 10 and the server apparatus 20 are separate apparatuses and that they constitute the imaging apparatus system 1. However, they need not necessarily be separate apparatuses. For example, with the enhancement in processing performance of the CPU 100 and/or the CPU 200 and the increase in capacity and the reduction in cost of the storage 202 for storing video data, the smart glasses 10 and the server apparatus 20 may be integrated into a single apparatus having a common housing. For example, if smart glasses are developed that have the same appearance as the smart glasses 10, generate video data, biometric data, etc., and is capable of emotion determination, all processing can be completed with that one smart glasses. Thus, it is not essential that it be a server-client system. The smart glasses themselves, which include the functions and configurations of the smart glasses 10 and the server apparatus 20 in a single housing, also fall under the scope of the imaging apparatus system.

The example has been described where the image sensor, the microphone, the motion sensor, biometric data, and line-of-sight data are provided on the smart glasses 10 side. However, as described above, they may be provided as equipment external to the smart glasses 10. A system encompassing these is the imaging apparatus system 1.

Although in the present disclosure, the smart glasses-type imaging apparatus is exemplified, the imaging apparatus can be a normal video camera that shoots a video while being held in the hand, a smartphone, or a digital camera having a video shooting function. No matter which one of these cameras is used or even if the camera configuration includes the functions and configuration of the server apparatus 20, it falls under the scope of the imaging apparatus system.

The present disclosure is applicable to an imaging apparatus system and a server apparatus.

What is claimed is:

1. An imaging apparatus system comprising:
one or more image sensors configured to generate video data by capturing images;
an interface device for acquiring data, the interface device acquiring at least one of audio data acquired during image capturing and biometric data that is biometric information of a user acquired during the image capturing;
a storage configured to record a data set in which at least one of the audio data and the biometric data is correlated with the video data; and
one or more signal processing circuits configured to determine an emotion the user felt regarding an event that was occurring at the time of the image capturing, using at least one of the video data, the audio data, and the biometric data, and configured to execute an image editing process on the video data depending on the determined emotion.

2. The imaging apparatus system according to claim 1, wherein
the one or more signal processing circuits grasp the event using the video data and determine an emotion the user felt at the event using at least one of the audio data and the biometric data.

3. The imaging apparatus system according to claim 2, wherein
the interface device acquires line-of-sight data indicating direction of the user's line of sight at the time of the image capturing, and wherein
the one or more signal processing circuits grasp the event using the video data and the line-of-sight data and determine an emotion the user felt at the event using at least one of the audio data and the biometric data.

4. The imaging apparatus system according to claim 1, wherein
the one or more image sensors comprise a first image sensor configured to capture images of a predetermined subject to generate first video data, and a second image sensor configured to capture images of the user's face to generate second video data, and wherein
the one or more signal processing circuits grasp the event using the first video data and determine an emotion the user felt at the event using the second video data and at least one of the audio data and the biometric data.

5. The imaging apparatus system according to claim 3, wherein
the one or more signal processing circuits calculate a first value from the audio data, calculate a second value from the biometric data, and calculate a third value from the line-of-sight data, and wherein the one or more signal processing circuits determine the emotion based on a total value from the first value to the third value.

6. The imaging apparatus system according to claim 1, wherein
in the one or more signal processing circuits, an event prediction model M is implemented in advance, the event prediction model M generated by machine learning, based on training data in which video and/or audio containing an event as an explanatory variable is correlated with a type of event as an objective variable, wherein
the one or more signal processing circuits predict a type of the event from the at least one data and the event prediction model and determine an image editing process based on the predicted type of event and the emotion, and wherein
the one or more signal processing circuits execute the determined image editing process on the video data.

7. The imaging apparatus system according to claim 1, wherein
the one or more signal processing circuits comprise a table that, for each type of the event, correlates each of a plurality of types of emotions with each of a plurality of image editing processes of video data, and wherein the one or more signal processing circuits refer to the table based on the predicted type of the event and the emotion, to determine the image editing process.

8. The imaging apparatus system according to claim 7, wherein
each of the plurality of image editing processes includes at least one of: adding a text or an image representing a mental image and/or a sentiment of a photographer; and adding an image of the user.

9. The imaging apparatus system according to claim 7, wherein
each of the plurality of image editing processes includes adding a text or an image representing a mental image and/or a sentiment of a photographer, generated from the audio data or the biometric data.

10. The imaging apparatus system according to claim 1, comprising:
an imaging apparatus and a server apparatus that are communicable with each other, wherein
the imaging apparatus comprises: the one or more image sensors configured to generate the video data; a microphone configured to generate the audio data; and a biometric sensor configured to generate the biometric data, and wherein
the server apparatus comprises: the storage; and the one or more signal processing circuits.

11. A server apparatus used in an imaging apparatus system having an imaging apparatus, the imaging apparatus including: an one or more image sensors configured to generate video data by capturing images; a microphone configured to generate audio data;
an interface device for acquiring biometric data; and a transmission circuit configured to transmit the video data and at least one of the audio data and the biometric data, the server apparatus comprising:
a communication circuit configured to communicate with the imaging apparatus;
a storage configured to record a data set in which at least one of the audio data and the biometric data is correlated with the video data received by the communication circuit; and
one or more signal processing circuits configured to determine an emotion the user felt regarding an event that was occurring at the time of the image capturing, using at least one of the audio data and the biometric data, and configured to execute an image editing process on the video data depending on the determined emotion or that analyzes an event indicating a factor of the user's emotion to generate factor analysis data.

12. The server apparatus according to claim 11, wherein
the server apparatus accepts, via the communication circuit, a request corresponding to generation of the video data on which the image editing process has been executed or creation of the factor analysis data, and wherein
the one or more signal processing circuits generate the video data on which the image editing process has been executed or creates the factor analysis data, depending on the content of the request.

13. The server apparatus according to claim 11, wherein
the factor analysis data generated by the one or more signal processing circuits includes factor analysis data preferred by the user and/or factor analysis data not preferred by the user.

14. The server apparatus according to claim 12, wherein
the server apparatus accepts, via the communication circuit, a specification of a specific interval of the video data to be subjected to the image editing process.
